(19) United States
(12) Patent Application Publication
(10) Pub. No.: US 2011/0137497 A1
(43) Pub. Date: Jun. 9, 2011

(54) AIRCRAFT PROVIDED WITH A DEVICE FOR ASSISTING THE PILOT WHEN CARRYING AN EXTERNAL LOAD WITH A SLING, AND A METHOD IMPLEMENTED BY SAID DEVICE

(75) Inventor: Florian Jimenez, Les Milles (FR)

(73) Assignee: EUROCOPTER, Marignane Cedex (FR)

(21) Appl. No.: 12/959,646

(22) Filed: Dec. 3, 2010

(30) Foreign Application Priority Data
Dec. 8, 2009 (FR) 09 05919

(51) Int. Cl. G05D 1/00

(52) U.S. Cl. 701/3

(57) ABSTRACT

The present invention relates to an aircraft (1) having a sling (3) fastened to a fastening point (9), a local transverse vertical plane (P1) containing said fastening point (9) being parallel to a yaw axis (AX1) and to a pitch axis (AX2), a local longitudinal vertical plane (P2) containing said fastening point (9) being parallel to a yaw axis (AX1) and to a roll axis (AX3), said local longitudinal and transverse vertical planes (P2 and P1) intersecting at a vertical axis (AX4). The aircraft (1) is provided with a piloting assistance device (10) comprising firstly main determination means (20) for determining a first main angle (α1) between said vertical axis (AX4) and a first primary projection (3′) of said sling (3) on said local transverse vertical plane (P1) and a second main angle (α2) between said vertical axis (AX4) and a second primary projection (3″) of said sling (3) on said local longitudinal vertical plane (P2); and secondly display means (30) provided with a display screen (31) for quantitatively displaying said first and second main angles (α1, α2).

### CROSS REFERENCE TO RELATED APPLICATION

This application claims the benefit of FR 09 05919 filed on Dec. 8, 2009, the disclosure of which is incorporated in its entirety by reference herein.

### FIELD OF THE INVENTION

The present invention relates to an aircraft having a device for assisting the pilot when carrying an external load with a sling, and to a method implemented by said device.

The technical field of the invention is thus that of devices for fastening an external load to an aircraft.

### BACKGROUND OF THE INVENTION

An aircraft, and more particularly a rotorcraft of the helicopter type, may optionally be fitted with an installation for transporting an external load.

Thus, the aircraft generally has a carrier structure, an optionally swiveling release hook being fastened to said carrier structure of the rotorcraft. A sling is then fastened to the release hook so as to enable heavy external loads to be carried.

The release hook may be fastened to the carrier structure by numerous means:

first means, sometimes referred to as a sling swivel, comprise a universal or cardan type joint having two mutually orthogonal pivot axes, with force from the sling being applied to the carrier structure at a point;

second means, sometimes referred to as swing means, comprise a frame that is suspended from the carrier structure by four suspension cables;

third means make use of a beam having the release hook attached thereto, the beam generally being fastened to the carrier structure via two points; and

fourth means using a pole fastened to the main gearbox of the rotorcraft, the release hook being hinged to the pole.

The release hook also serves to jettison the external load in flight, so as to release the external load at a given position, or when an emergency situation arises.

In flight, the sling connected to the aircraft tends to move relative thereto, and that can lead to accidents.

Firstly, it is common practice to use a rotorcraft with a sling for putting a heavy external load in position at a precise location. Under difficult flying conditions, the load may become blocked against an obstacle, may damage an external element, such as a building, or may indeed strike an operator.

Certification regulations that need to be complied with in order to obtain flight authorization do not require particular monitoring systems. In contrast, operating regulations sometimes require precautions to be taken, such as using rearview mirrors in order to monitor the swinging of the sling, for example.

Secondly, if the external load on the sling catches on an obstacle on the ground, the rotorcraft is blocked. Because of the inertia of the rotorcraft, large forces are exerted on the sling. Those forces may give rise to the sling breaking in order to release the rotorcraft.

However, given the suddenness of such a maneuver, the inclination of the disk formed by the blades of the rotor may oscillate rearwards during a transient stage. The blades then run the risk of striking or even cutting off the tail boom of the rotorcraft.

In addition, the portion of sling that remains attached to the rotorcraft tends to whip upwards and runs the risk of becoming tangled in a rotor of the rotorcraft.

It can thus be understood that it is advantageous to monitor the external load in order to avoid an accident.

The following documents present the technological background of load transport installations.

More precisely, document GB 2437407 discloses the existence of a system provided with a hook for suspending a load and with means for detaching the load.

Document FR 2575550 presents a system that delivers in real time the weight supported by the release hooks to which an external load is secured.

Finally, document FR 2197766 provides explosive means to separate the hook supporting the load and to cut the sling.

Furthermore, in order to avoid an accident caused by the sling carrying an external load taking up excessive slope, various devices are known.

Document EP 0259250 shows a helicopter having suspended therefrom a skip that is provided with stabilizers.

Document FR 2149777 presents a system for stabilizing an external load beneath an aircraft by making provision to act on the flight controls so that the aircraft performs correcting movements to attenuate swinging motion of the external load. Adjustment is performed by using the rate of variation in the angle between a support cable and the weight axis.

Document JP 1996/0101019 describes a winch suitable for limiting the accelerations suffered by a body that is suspended from the winch via a sling.

Document GB 1074465 describes a device for limiting the swing angle of a sling fastened to a winch, relative to the weight axis.

The same applies to document U.S. Pat. No. 3,904,156 which provides for actuators to act on a rigid sling.

Those devices are advantageous but then tend to exclude the pilot. Those devices are of the active type and they do not allow the pilot to act or to take decisions as a function of a given situation.

Document FR 2661887 provides a device that enables a pilot to maintain a sling along the weight axis while hovering. That device is provided with two inclination detectors to deliver the angle of inclination of the sling relative to the weight axis, and also a display system provided with two crossed needles that are controlled by the information coming from respective ones of said two detectors.

While hovering, that device serves to assist the pilot in maneuvering the rotorcraft.

Nevertheless, that device does not appear to be effective in all flying configurations.

Furthermore, document WO 2007/1132454 discloses means for viewing a zone in which a helicopter is to deliver an external load.

Document EP 1146317 proposes an artificial horizon displaying the pitch angle of a helicopter and an additive superimposition of the pitch angle and the time derivative of the angle between the earth normal and the direction in which the load acts on said helicopter.

The technological background also includes document WO 2007/042492 relating to a luminous single indicating an approach angle to an aircraft.

### SUMMARY OF THE INVENTION

An object of the present invention is thus to propose an aircraft carrying an external load via a suspended sling and having a device for assisting piloting that enables the pilot of the aircraft to avoid any incident caused by the external load and/or the sling, with the pilot remaining in charge of the situation.

It should be observed that in the text below, the term “sling” is used to cover any elongate means enabling a load to be lifted, namely a cable, a bar, or indeed means provided with both a bar and a cable, for example.

According to the invention, an aircraft is provided with an airframe and a sling fastened to the airframe via a carrier structure, the sling being fastened to a fastening point of the carrier structure, a local transverse vertical plane containing the fastening point being parallel to a yaw axis and to a pitch axis of the aircraft, a local longitudinal vertical plane containing the fastening point being parallel to a yaw axis and to a roll axis of the aircraft, the local longitudinal and transverse vertical planes intersecting at a vertical axis of the aircraft.

It should be observed that the term “local” is used insofar as the local planes are associated with the frame of reference of the aircraft. As explained below, the term “absolute” is used to specify planes that are associated with the terrestrial frame of reference.

This aircraft is remarkable in that it is provided with a piloting assistance device comprising:

main determination means for determining a first main angle between the vertical axis and a first primary projection of the sling on the local transverse vertical plane and a second main angle between the vertical axis and a second primary projection of the sling on the local longitudinal vertical plane; and

display means provided with a display screen for quantitatively displaying the first and second main angles.

Consequently, the determination means evaluate the first main angle and the second main angle so as to estimate the angle of the sling relative to the airframe of the aircraft, e.g. a rotorcraft of the helicopter type, and specifically unlike that which is described in document FR 2 661 887.

The invention thus continues to be effective regardless of the stage of flight, even while flying forwards or turning.

The display means enable the pilot to know the values of the first main angle and the second main angle. The pilot can then carry out maneuvers to ensure that the first and second main angles do not reach levels that might correspond to an incident.

Furthermore, the display means enable the pilot to visualize the position of the sling relative to the airframe easily, and in particular without having to use a rearview mirror.

The piloting assistance device thus assists the pilot by providing help in anticipating potential incidents.

The piloting assistance device, and consequently the aircraft provided with the device, may also include one or more of the following characteristics.

Thus, the display means may present:

first straight line and second straight line intersecting at a point of intersection representing the vertical axis, the first straight line being the abscissa of a diagram giving the first main angle, and the second straight line being the ordinate of the diagram giving the second main angle; and

a plurality of closed limit lines each defining a corresponding zone of given criticality.

In other words, the first straight line represents the trace of the local transverse vertical plane on a local horizontal plane orthogonal to the local transverse vertical plane and to the local longitudinal vertical plane, the second straight line representing the second trace of the local longitudinal vertical plane on a local horizontal plane.

Under such circumstances, the display means advantageously display in real time a mark representing the sling in said diagram, the mark being movable as a function of the position of the sling relative to said airframe.

For example, the mark may be a light spot giving values for the first main angle and the second main angle. By projecting the light spot orthogonally onto the abscissa of the diagram, and knowing the scale used on the abscissa, the pilot obtains the first main angle. Similarly, by projecting the light spot orthogonally onto the ordinate of the diagram, and knowing the scale used for the ordinate, the pilot obtains the second main angle.

At least one limit line is optionally a concentric circle centered on the point of intersection, i.e. the center of the diagram.

For example, the display means may present a plurality of concentric circular limit lines, or indeed all of the limit lines may be circular.

In order to assist the pilot of the aircraft more effectively, the display means comprise a first zone between the point of intersection and a first limit line in which a position of the sling relative to the vertical axis as determined using the pair comprising the first main angle and the second main angle is an optimum position smaller than a first predetermined limit position represented by the first limit line.

The display means may also comprise a second zone between a first limit line and a second limit line surrounding the first limit line, in which a position of the sling relative to the vertical axis as determined using the pair constituted by the first main angle and the second main angle is an acceptable position lying between the predetermined first limit position and a predetermined second limit position represented by the second limit line.

This second predetermined limit may correspond to a limit imposed by certain regulations, i.e. a limit of 30 degrees applicable to the first main angle and the second main angle.

Furthermore, the display means may also comprise a third zone between a second limit line and a third limit line surrounding the second limit line, in which a position of the sling relative to the vertical axis as determined using the pair comprising the first main angle and the second main angle is a risky position situated between the second predetermined limit and a third predetermined limit represented by the third limit line.

It is authorized to go into the third zone insofar as the pilot can still maneuver the aircraft so as to place the sling in the first and second zones.

However, the display means may optionally include a fourth zone beyond a third limit line surrounding a second limit line and in which at least the first or the second main angle has a value that is forbidden.

If the sling lies in the fourth zone, then the maneuvering capacity of the aircraft no longer allows the pilot to return into a more favorable zone. The pilot must therefore release the sling by acting on a release hook.

Furthermore, said display means include a fourth limit line optionally surrounding a third limit line to limit said fourth zone.

In addition, the piloting assistance device may include audible alarm means suitable for delivering an audible signal when the mark is positioned in one of the zones, the audible signal varying from one zone to another.

Thus, if the mark is situated in the first zone, the device issues a first sound signal, if the mark is situated in the second zone, the device issues a second sound signal, if the mark is situated in the third zone, the device issues a third sound signal, and if the mark is situated in the fourth zone the device issues a fourth sound signal.

The sound signal may be triggered by the display means, e.g. on receiving an order from the determination means.

In order to determine the first main angle and the second main angle, the determination means may comprise a processor and a memory, the processor making use of dedicated instruments.

In a first embodiment, the sling comprises a bar having a plurality of targets and hooked to the fastening point, and the device is provided with at least two optical measurement means connected to the main determination means, the main determination means determining the first and second main angles as a function of the targets viewed by said optical measurement means.

The optical measurement means may comprise a laser or stereoscopic video cameras.

The determination means determine the first and second main angles as a function of the viewed targets. For example, a processor of the determination means may use a table giving said main angles as a function of said target, the table being established by testing.

In a second embodiment, the carrier structure includes mutually orthogonal first and second pivot axes and the device comprises:

a first angle sensor arranged on the first pivot axis, the first sensor being connected to the main determination means to transmit thereto a signal relating to the first main angle; and

a second angle sensor arranged on the second pivot axis, the second sensor being connected to the main determination means to transmit thereto a signal relating to the second main angle.

The first angle sensor and the second angle sensor may for example be potentiometers, with the voltages delivered by the potentiometers to the determination means varying as a function of the angular positions of the associated pivot axes.

In a third embodiment, an absolute horizontal plane containing said fastening point and extending perpendicularly to the weight axis applied to said fastening point, a longitudinal vertical plane in roll containing said fastening point and presenting an angle equal to a roll angle of said aircraft relative to said local longitudinal vertical plane, and a transverse vertical plane in pitching containing said fastening point and presenting an angle equal to a pitch angle of said aircraft relative to said local transverse vertical plane, said device includes first angle measurement means secured to said aircraft and connected to said determination means to transmit to said main determination means information relating to a roll angle and a pitch angle of said aircraft.

Furthermore, the device includes second angle measurement means connected to the main determination means to transmit to the main determination means information relating to a first secondary angle between a first secondary projection of the sling on a local transverse vertical plane and the weight axis applied to the fastening point and relating also to a second secondary angle between a second secondary projection of the sling on a local longitudinal vertical plane and the weight axis applied to the fastening point.

The determination means then determine the first main angle by subtracting the roll angle from the first secondary angle. Similarly, the determination means then determine the second main angle by subtracting the pitch angle from the second secondary angle.

In other words, the angle of the sling relative to the weight axis and the angle of the airframe of the aircraft relative to the weight axis are determined, and then the angle of the sling relative to the airframe is deduced therefrom.

In addition to an aircraft, the invention provides a method of assisting the piloting of an aircraft having an airframe and a sling fastened to the airframe via a carrier structure, the sling being fastened to a fastening point of the carrier structure, a local transverse vertical plane containing the fastening point being parallel to a yaw axis and to a pitch axis of the aircraft, a local longitudinal vertical plane containing the fastening point being parallel to a yaw axis and to a roll axis of the aircraft, the local longitudinal and transverse vertical planes intersecting at a vertical axis of the aircraft, the method comprising the following steps:

determining a first main angle between the vertical axis and a first primary projection of the sling on the local transverse vertical plane and a second main angle between the vertical axis and a second primary projection of the sling on the local longitudinal vertical plane; and

quantitatively displaying the first main angle and the second main angle so as to present them to a pilot of the aircraft.

The aircraft may be a rotary wing aircraft, such as a helicopter.

Optionally, a display screen presents, possibly in unvarying manner:

first straight line and second straight line intersecting at a point of intersection representing the vertical axis, the first straight line being an abscissa of a diagram giving the first main angle, and the second straight line being the ordinate of the diagram giving the second main angle; and

a plurality of closed limit lines each defining a corresponding zone of given criticality; and

a mark representing the position of the sling is displayed in real time in the diagram, the mark being movable as a function of the position of the sling relative to the airframe.

The present invention also provides a method of fabricating the above-specified device.

### BRIEF DESCRIPTION OF THE DRAWINGS

The invention and its advantages appear in greater detail from the following description of embodiments given by way of illustration with reference to the accompanying figures, in which:

FIG. 1 is a diagrammatic longitudinal section view of an aircraft of the invention;

FIG. 2 is a transverse view of an aircraft of the invention;

FIGS. 3 and 4 are diagrams explaining the first and second main angles which are determined;

FIG. 5 is a diagram showing display means of the invention;

FIG. 6 is a diagram showing a first embodiment;

FIGS. 7 and 8 are diagrams showing a second embodiment; and

FIG. 9 is a diagram showing a third embodiment.

Elements that are present in more than one of the figures are given the same references in each of them.

### DETAILED DESCRIPTION OF THE PREFERRED EMBODIMENT

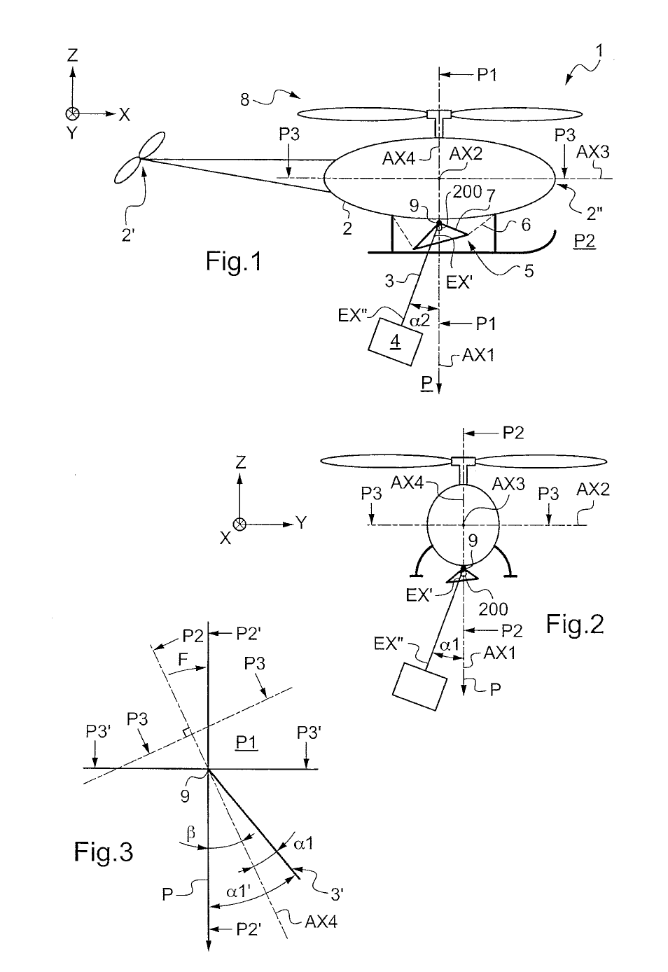

It should be observed that three mutually orthogonal directions, X, Y, and Z are identified in FIGS. 1, 2, 6, 7, and 8. The direction X is said to be longitudinal, another direction Y is said to be transverse, and a third direction Z is said to be in elevation.

FIG. 1 is a diagrammatic view of an aircraft 1 of the invention.

The aircraft 1 comprises an airframe 2 that extends longitudinally from a rear end 2′ to a front end 2″ along a longitudinal direction X. Furthermore, the aircraft 1 as shown is a rotary wing aircraft 8, more particularly a rotorcraft of the helicopter type having a main rotor 8 for propulsion and lift.

In order to be able to carry an external load 4, the aircraft includes a carrier structure 5 provided with a fastening point 9. The carrier structure shown in FIG. 1 is of the swing type, comprising a frame 5 that is suspended from the airframe 2 by cables 6. Nevertheless, the carrier structure could be of some other type without going beyond the ambit of the invention.

A first end EX′ of a sling 3 is then fastened to a release hook 200, said release hook 200 being itself secured to the aircraft 1 via the fastening point 9. The external load 4 is attached to the second end EX″ of the sling 3.

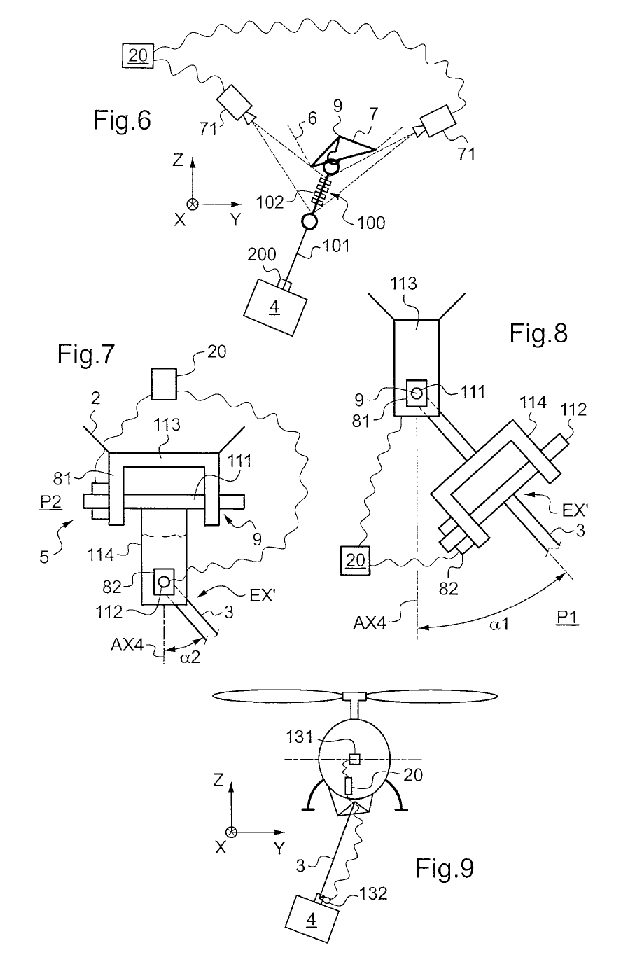

It should be observed that FIGS. 6, 7, and 8 show a variant, the first end EX′ of a sling 3 being fastened to the fastener point 9, while a second end EX″ of the sling 3 is provided with a release hook 200, the release hook carrying the external load.

The sling may comprise solely a flexible section, e.g. constituted by a cable, solely a rigid section, e.g. constituted by a bar, or indeed both a flexible section and a rigid section.

Conventionally, the aircraft is suitable for turning about a yaw axis AX1, a pitch axis AX2, and a roll axis AX3. By controlling the yaw angle, the pitch angle, and the roll angle, the pilot can direct the aircraft.

Using these axes, it is possible to define local planes tied to the aircraft, i.e. a transverse vertical plane P1 containing the fastening point 9 and parallel to the yaw and pitch axes AX1 and AX2. It should be observed that the yaw and pitch axes AX1 and AX2 may be contained in the transverse vertical plane P1.

Similarly, it is possible to define a local longitudinal vertical plane P2 containing the fastening point 9 and parallel to the yaw axis AX1 and the roll axis AX3, the local longitudinal and transverse planes P2 and P1 intersecting at a vertical axis AX4 of the aircraft 1. The local longitudinal vertical plane P2 corresponds to the plane of the sheet on which FIG. 1 is drawn, and the vertical axis may coincide with the weight axis P.

Finally, a local horizontal plane P3 may be defined that is orthogonal to the transverse vertical plane P1 and to the longitudinal vertical plane P2, the local horizontal plane P3 containing the pitch axis AX2, for example.

In flight, i.e. during forward flight or during hovering flight, the sling 3 may be caused to swing.

With reference to FIG. 1, the sling may swing from front to rear so as to approach the rear of the aircraft, with the opposite also being possible. Similarly, with reference to FIG. 2, the sling may swing from the port side of the aircraft towards its starboard side so as to move towards the starboard side, with the opposite also being possible. Furthermore, these two types of movements may be combined.

With reference to FIG. 3, in the invention the value is determined for a first main angle α1 between a first projection 3′ of the sling 3 on the local transverse vertical plane P1 and the vertical axis AX4.

In FIG. 3, it can also be seen that the weight axis P passes via the fastening point 9 as does an absolute horizontal plane P3′, this absolute horizontal plane P3′ also being perpendicular to the weight axis P. In the event of the aircraft rolling, the vertical axis AX4 presents an angle equal to the roll axis β of the aircraft relative to a longitudinal vertical plane P2′ in roll, a longitudinal vertical plane P2′ in roll being obtained by causing the local longitudinal vertical plane P2 to turn about the fastening point 9 through a roll angle β in the direction of arrow F.

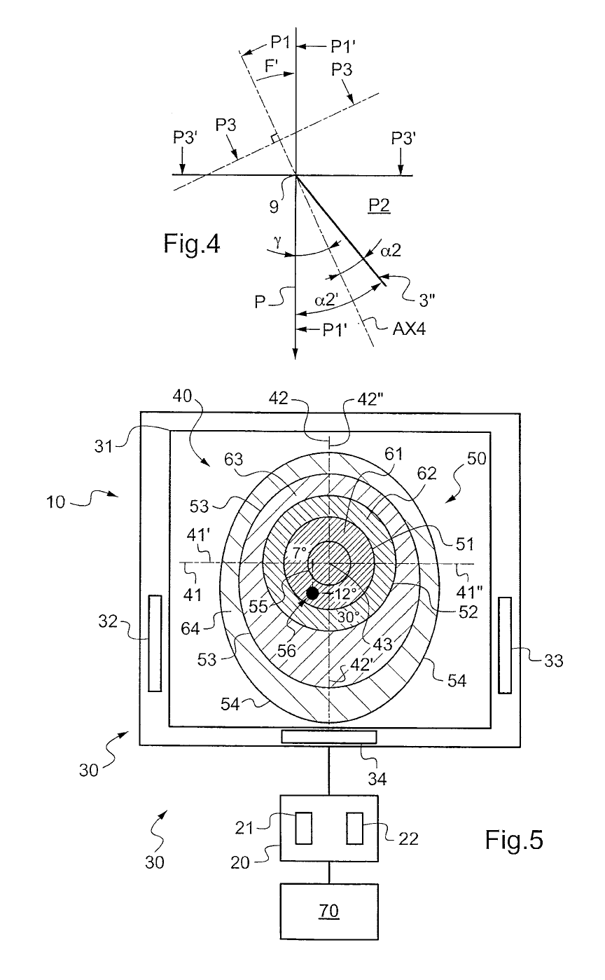

With reference to FIG. 4, a value is also determined for a second main angle α2 present between a second projection 3″ of the sling 3 on the local longitudinal vertical plane P2 and the vertical axis AX4.

In the event of the aircraft performing pitching movement, this vertical axis AX4 presents an angle equal to the pitch angle γ of the aircraft relative to the transverse vertical plane P1′ in pitching, this transverse vertical plane P1′ in pitching being obtained by turning the local transverse vertical plane P1 about the fastening point 9 through a pitch angle γ in the direction of arrow F′.

Under such circumstances, the first main angle and the second main angle determined are displayed quantitatively in real time so they can be seen by a pilot. This quantitative display may be the result of displaying the values of the first main angle and the second main angle digitally, using a needle, and/or using a diagram, e.g. presenting the value of the first main angle along the abscissa and the value of the second main angle up the ordinate.

This diagram solution is advantageous insofar as it provides a visual indication of the position of the sling relative to the airframe of the aircraft, and thus relative to the pilot. It can be understood that it makes it easy for the pilot to visualize the angle of the sling.

FIG. 5 shows a device 10 for providing assistance in piloting an aircraft 1 having a sling 3 and implementing the above-described method.

The device 10 includes determination means 20 that co-operate with instruments 70, the instruments 70 sending to the determination means information relating to the first main angle α1 and the second main angle α2.

For example, the determination means 20 comprise a first processor 21 and a memory 22, the processor making use of tables stored in said memory 22 to determine said first main angle α1 and the second main angle α2 as a function of said information.

The determination means operate continuously during flight to calculate in real time the first main angle α1 and the second main angle α2.

Furthermore, the device 10 includes display means 30 that display the first main angle α1 and the second main angle α2 on a display screen 31.

For example, the determination means transmit the first main angle α1 and the second main angle α2 to a second processor 34 of the display means, the second processor causing the first main angle α1 and the second main angle α2 to be displayed on the display screen 31. It should be observed that the determination means may be integrated in the display means, the first and second processors 21 and 34 possibly constituting a single processor performing several functions.

Once it is switched on, the display screen shows first straight line 41 and the second straight lines 42 that intersect at a point of intersection 43. These first straight line 41 and the second straight line are mutually perpendicular and they represent respectively the abscissa and the ordinate of a diagram 40. The first straight line relates to the first main angle α1 expressed in degrees, the second straight line relating to the second main angle α2 expressed in degrees.

By convention, consideration may be given to a first primary half-line 41′ going from the point of intersection 43 towards the left of the sheet on which FIG. 5 is drawn and representing the port side of the aircraft, the first main angle α1 having a negative value on this side. Conversely, consideration may be given to a first primary half-line 41″ going from the point of intersection 43 towards the right of the sheet on which FIG. 5 is drawn, representing the starboard side of the aircraft, the first main angle α1 having a positive value on this side.

Similarly, consideration may be given to a second primary half-line 42′ going from the point of intersection 43 towards the bottom of the sheet on which FIG. 5 is drawn and representing the rear 2′ of the aircraft, the second main angle α2 having a negative value towards the rear. Conversely, consideration may be given to a second secondary half-line 42″ going from the point of intersection 43 towards the top of the sheet on which FIG. 5 is drawn and representing the front 2′ of the aircraft, the second main angle α2 having a positive value towards the front.

By positioning a mark 56 relating to the angle of inclination of the sling 3, the display means do indeed display quantitatively the first main angle α1 and the second main angle α2. Projecting this mark 56 orthogonally onto the first straight line 41 and the second straight line 42 tells the pilot immediately the values of the first and second main angles α1 and α2 providing the pilot knows the scale along these straight lines. In order to facilitate pilot observation, the first and second straight lines may be graduated.

Furthermore, the display means may also display the numerical values of the first and second main angles α1 and α2.

For example, in FIG. 5, the first main angle α1 is equal to −7 degrees, while the second main angle α2 is equal to −12 degrees.

Furthermore, the display means display a plurality of closed limit lines 50 each defining a zone associated with a given level of risk. These limit lines may be circular and centered on the point of intersection or they may have some other configuration.

Thus, the display means may display a first limit line 51 defining a first zone 61, the first zone 61 thus being situated between the point of intersection 43 and said first limit line.

The first limit line 51 as shown corresponds to a sling in a position presenting an angle of 20 degrees relative to the vertical axis AX4. It can be understood that any combination of the first and second main angles generating an angle of inclination for the sling of 20 degrees relative to the vertical axis AX4 causes the mark 56 to be located on the first limit line 51.

Furthermore, the display means include a second circular limit line 52 surrounding the first limit line 51. The first limit line 51 and the second limit line 52 are concentric in the example shown, and between them they define a second zone 62.

A third limit line 53 that can be said to be somewhat egg-shaped surrounds the second limit line 52 so as to define a third zone 63.

Beyond the third zone there is a fourth zone 64. Possibly, the display means displays a fourth limit line 54 that surrounds the third limit line in order to limit the fourth zone.

It should be observed that the display means may include intermediate lines to enhance readability, such as the intermediate line 55 situated between the point of intersection 43 and the first limit line 51.

Depending on the position of the sling 3 relative to the airframe 2, and in particular relative to the vertical axis AX4, the mark 56 moves about the diagram 40 in real time.

When the mark is in the first zone 61, the position of the sling 3 relative to the vertical axis AX4, as determined using the pair constituted by the first main angle α1 and the second main angle α2, is an optimum position smaller than a first predetermined limit position LIM1 that is represented by the first limit line 51.

If the sling 3 continues to swing, the mark 56 may move into the second zone 62. The position of the sling relative to the vertical axis AX4 as determined using the pair comprising the first main angle α1 and the second main angle α2 is a position that is acceptable, i.e. it lies between the first predetermined limit position LIM1 and a second predetermined limit position LIM2 as represented by the second limit line 52.

The second predetermined limit position LIM2 corresponds to a limit that is normally authorized, e.g. an angle of 30 degrees between the sling and the vertical axis AX4. The first predetermined limit LIM1 is determined by taking a safety margin relative to the second predetermined limit position LIM2.

Thus, when the marking 56 is in the first zone 61 the pilot knows not only that the sling 3 is in no risk of giving rise to an incident, but also that there is a considerable margin before reaching the second predetermined limit LIM2. However, once the second zone 62 is reached, the pilot needs to be vigilant.

The first and second zones 61 and 62 together represent a risk-free authorized operating zone.

Normally, the pilot should prevent the sling 3 from moving into the third zone 63, i.e. when the position of the sling 3 relative to the vertical axis AX4, as determined using the pair comprising the first main angle α1 and the second main angle α2 is a risky position situated between the second predetermined limit LIM2 and a third predetermined limit LIM3 represented by the third limit line 53. This third predetermined limit LIM3 takes account of the capacity of the aircraft to maneuver.

When the mark 56 reaches the third zone 63, the sling is in a position that is potentially dangerous. Nevertheless, the pilot is informed that the capacity of the aircraft 1 for maneuvering ought to enable the sling 3 to be repositioned in the first or the second zone 61 or 62.

The third zone 63 is thus a risky zone.

Finally, in the forbidden fourth zone 64 situated beyond the third predetermined limit LIM3, the pilot can no longer return to a safe configuration. It is necessary to jettison the sling 3.

It should be observed that the device 10 may be associated with an automatic jettisoning device. For example, the external load 4 may be jettisoned when the third zone is reached, such jettisoning taking effect for example as a function of some additional parameter, such as the tension exerted on the sling 3. In contrast, once the fourth zone 64 is reached, the external load is jettisoned independently of any other parameter.

It should be observed that on the diagram the lines defining said zones may optionally be displayed in unchangeable manner. Thus, with such a diagram, the limit lines and said zones do not change during a flight insofar as they correspond to a given type of aircraft.

Furthermore, the device 10 may include audible alarm means, e.g. loudspeakers 32 and 33 arranged on the display means 30. Each zone is associated with a dedicated sound signal. Without looking at the display screen, the pilot can still be informed about the zone in which the mark 56 is positioned.

In the first embodiment shown in FIG. 6, the sling 3 comprises a bar 100 extended by a bottom portion 101. The bar 100 is then fastened to the fastening point 9, while the bottom portion is provided with a release hook 200.

The bar 100 is also provided with a plurality of targets 100.

The instruments 70 communicating with the determination means 20 then include two optical measurement means 71, e.g. stereoscopic video cameras. The optical measurement means then inform the determination means 20 about the targets they identify. The determination means 20 use the memory 22 to deduce therefrom the first and second main angles α1 and α2.

FIGS. 7 and 8 show a second embodiment provided with a carrier structure 5 of the swivel type. Thus, the carrier structure has first and second pivot axes 111 and 112.

More precisely, a first fork 113 with an upside-down U-shape is fastened to the airframe 2 of the aircraft, and carries the first pivot axis 111.

The first pivot axis is secured to a second fork 114 in the form of an upside-down U-shape passing a second pivot axis 112. The sling is then secured to the second pivot axis 112.

The instruments 70 then include a first angle sensor 81, e.g. of the potentiometer type, arranged on the first pivot axis 111. In addition, the instruments then also include a second angle sensor 82, e.g. of the potentiometer type, arranged on the second pivot axis 112. The first and second sensors provide the angle determination means 20 respectively with information relating to the first and second main angles.

Finally, FIG. 9 shows a third embodiment.

The instruments 70 are provided with first angle measurement mean 131 and the second angle measurement mean 132 that are connected to the determination means 20.

The first angle measurement means 131 is secured to the airframe 2 so as to provide the determination means 20 with the roll angle β as shown in FIG. 3 and the pitch angle γ as shown in FIG. 4. These first angle measurement means 131 may be an inertial unit of the aircraft or a dedicated bidirectional inclinometer.

The second angle measurement means 132 are secured to the sling to transmit to the determination means a first secondary angle α1′ between a first projection 3′ of said sling 3 on a local transverse vertical plane P1 and the weight axis P applied at the fastening point 9, and a second secondary angle α2′ between a second projection 3″ of the sling 3 on a local longitudinal vertical plane P2 and said weight axis P. The second angular measurement means 132 may be constituted for example by a bidirectional inclinometer arranged on the release hook 200.

The determination means then calculate the first main angle α1 by subtracting the roll angle β from the first secondary angle α1′, and the second main angle α2 by subtracting the pitch angle γ from the second secondary angle α2′.

Naturally, the present invention may be subjected to numerous variations as to its implementation. Although several embodiments are described above, it will readily be understood that it is not conceivable to identify exhaustively all possible embodiments. It is naturally possible to replace any of the means described by equivalent means without going beyond the ambit of the present invention.

For example, the display means may display firstly limit lines and secondly concentric circles centered on the point of intersection between the first and second straight lines 41 and 42.

The limit lines may be unmoving throughout a flight. Nevertheless, it is possible for the shape of the limit lines to vary in real time as a function of flying conditions, e.g. as a function of the tension in the sling, where said tension varies in particular as a function of load factors.

What is claimed is:

1. An aircraft having an airframe and a sling fastened to said airframe via a carrier structure, said sling being fastened to a fastening point of said carrier structure, a local transverse vertical plane (P1) containing said fastening point being parallel to a yaw axis (AX1) and to a pitch axis (AX2) of said aircraft, a local longitudinal vertical plane (P2) containing said fastening point being parallel to a yaw axis (AX1) and to a roll axis (AX3) of said aircraft, said local longitudinal and transverse vertical planes (P2 and P1) intersecting at a vertical axis (AX4) of said aircraft, wherein said aircraft is provided with a piloting assistance device comprising:
main determination means for determining a first main angle (α1) between said vertical axis (AX4) and a first primary projection of said sling on said local transverse vertical plane (P1) and a second main angle (α2) between said vertical axis (AX4) and a second primary projection (3″) of said sling on said local longitudinal vertical plane (P2); and
display means provided with a display screen for quantitatively displaying said first and second main angles (α1, α2).

2. An aircraft according to claim 1, wherein said display means present:
first straight line and second straight line intersecting at a point of intersection representing said vertical axis (AX4), the first straight line being the abscissa of a diagram giving said first main angle (α1), and the second straight line being the ordinate of said diagram giving said second main angle (α2); and
a plurality of closed limit lines each defining a corresponding zone of given criticality; and
said display means act in real time to display a mark representing said sling in said diagram, said mark being movable as a function of the position of the sling relative to said airframe.

3. An aircraft according to claim 2, wherein at least one limit line is a circle centered on said point of intersection.

4. An aircraft according to claim 2, wherein said display means comprise:
a first zone between said point of intersection and a first limit line in which a position of the sling relative to the vertical axis (AX4) as determined using the pair comprising the first main angle (α1) and the second main angle (α2) is an optimum position smaller than a first predetermined limit position represented by the first limit line;
a second zone between a first limit line and a second limit line surrounding said first limit line, in which a position of the sling relative to the vertical axis (AX4) as determined using the pair constituted by the first main angle (α1) and the second main angle (α2) is an acceptable position lying between the predetermined first limit position and a predetermined second limit position represented by the second limit line; and
a third zone between a second limit line and a third limit line surrounding said second limit line, in which a position of the sling relative to the vertical axis (AX4) as determined using the pair comprising the first main angle (α1) and the second main angle (α2) is a risky position situated between the second predetermined limit and a third predetermined limit represented by the third limit line.

5. An aircraft according to claim 4, wherein said display means include a forbidden fourth zone beyond a third limit line surrounding a second limit line.

6. An aircraft according to claim 5, wherein said display means include a fourth limit line surrounding a third limit line to limit said fourth zone.

7. An aircraft according to claim 4, wherein said device includes audible alarm means suitable for delivering an audible signal when said mark is positioned in one of said zones, said audible signal varying from one zone to another.

8. An aircraft according to claim 1, wherein said carrier structure includes mutually orthogonal first pivot axis and second pivot axis and said device comprises:
a first angle sensor arranged on said first pivot axis, said first sensor being connected to said main determination means to transmit thereto a signal relating to said first main angle (α1); and
a second angle sensor arranged on said second pivot axis, said second sensor being connected to said main determination means to transmit thereto a signal relating to said second main angle (α2).

9. An aircraft according to claim 1, wherein for an absolute horizontal plane (P3′) containing said fastening point and extending perpendicularly to the weight axis (P) applied to said fastening point, a longitudinal vertical plane (P2′) in roll containing said fastening point and presenting an angle equal to a roll angle (β) of said aircraft relative to said local longitudinal vertical plane (P2), and a transverse vertical plane (P1′) in pitching containing said fastening point and presenting an angle equal to a pitch angle (γ) of said aircraft relative to said local transverse vertical plane (P1), said device includes first angle measurement means secured to said aircraft and connected to said determination means to transmit to said main determination means information relating to a roll angle (β) and a pitch angle (γ) of said aircraft, said device including second angle measurement means connected to said main determination means to transmit to said main determination means information relating to a first secondary angle (α1′) between a first projection (3′) of said sling on a local transverse vertical plane (P1) and said weight axis (P) applied to said fastening point and relating also to a second secondary angle (α2′) between a second projection (3″) of said sling on a local longitudinal vertical plane (P2) and said weight axis (P) applied to said fastening point.

10. A method of assisting the piloting of an aircraft having an airframe and a sling fastened to said airframe via a carrier structure, said sling being fastened to a fastening point of said carrier structure, a local transverse vertical plane (P1) containing said fastening point being parallel to a yaw axis (AX1) and to a pitch axis (AX2) of said aircraft, a local longitudinal vertical plane (P2) containing said fastening point (9) being parallel to a yaw axis (AX1) and to a roll axis (AX3) of said aircraft (1), said local longitudinal and transverse vertical planes (P2 and P1) intersecting at a vertical axis (AX4) of said aircraft (1), said method comprising the following steps:
determining a first main angle (α1) between said vertical axis (AX4) and a first primary projection (3′) of said sling on said local transverse vertical plane (P1) and a second main angle (α2) between said vertical axis (AX4) and a second primary projection (3″) of said sling on said local longitudinal vertical plane (P2); and
quantitatively displaying said first main angle (α1) and second main angle (α2) so as to present them to a pilot of said aircraft.

11. A method according to claim 10, further comprising the step of providing a display screen that presents:
first and second straight lines intersecting at a point of intersection representing said vertical axis (AX4), the first straight line being an abscissa of a diagram giving said first main angle (α1), and the second straight line being the ordinate of said diagram giving said second main angle (α2);
a plurality of closed limit lines each defining a corresponding zone of given criticality; and
a mark representing the position of said sling is displayed in real time in said diagram, said mark being movable as a function of the position of the sling relative to said airframe.
